(19) United States
(12) Patent Application Publication
(10) Pub. No.: US 2001/0046534 A1
(43) Pub. Date: Nov. 29, 2001

(54) Method for packaging baking ingredients

(76) Inventor: Grant D. Green, Los Altos, CA (US)

Correspondence Address: Grant D. Green, 1626 Parkhills Ave., Los Altos, CA, 94024, US

(21) Appl. No.: 09/777,418

(22) Filed: Feb. 6, 2001

Related U.S. Application Data
(60) Provisional application No. 60/180,898, filed on Feb. 7, 2000.

(51) Int. Cl. B65D 85/00; A21C 1/00

(52) U.S. Cl. 426/87; 426/112

(57) ABSTRACT

Brown sugar and similar ingredients are packaged for consumers in individual, pre-measured portions. The portions can be loosely packed, but correspond to a volume of firmly packed ingredient commonly used for cooking. Alternatively, the ingredient can be provided in a firmly packed form, in a pre-measured portion, or a pre-measured portion that is easily divisible into smaller portions that correspond to commonly-used cooking measures.

This application claims priority from U.S. Ser. No. 60/180,898 filed Feb. 7, 2000, incorporated herein by reference in full.

### FIELD OF THE INVENTION

This invention relates to the fields of food technology and packaging. More specifically, the invention relates to baking ingredients packed in convenient pre-measured portions, and methods for effecting such packaging.

### BACKGROUND OF THE INVENTION

Most processed ingredients currently used in cooking are commercially provided in small “bulk” containers, for example granulated sugar and flour in 1 lb, 5 lb, and 10 lb bags in the United States (with corresponding gradations, such as 0.5 kg, 1 kg, and the like elsewhere). While such packaging is reasonably convenient for most ingredients that take the form of liquids or freely-flowing powders, it is less convenient for moist or cohesive ingredients such as brown sugar, shredded coconut, granulated chocolate, and the like. These problematic ingredients are prone to cohere into a solid mass that is difficult to extract from the bulk package, particularly if exposed to heat or altered humidity, and are difficult to measure accurately for use in cooking. Brown sugar is most often packaged in a reclosable cardboard box lined with waxed paper, although it is sometimes packaged in resealable plastic bags or plastic screw-top containers.

### SUMMARY OF THE INVENTION

I have now invented an improved method for packaging problematic ingredients.

One object of the invention is to provide a package that simplifies the process of measuring and using ingredients such as brown sugar.

Another object of the invention is to provide a package that maintains ingredients such as brown sugar free of excessive moisture.

Another object of the invention is to provide a package that permits one to measure and use a desired amount of an ingredient such as brown sugar without the need to compact it firmly, followed by unpacking.

One aspect of the invention is a packaged article comprising: a pre-measured portion of a granular baking ingredient corresponding to a common recipe measure, enclosed in a suitable container. Another aspect of the invention is the article comprising brown sugar, wherein the brown sugar loosely packed, and the pre-measured portion is an amount equivalent to a pre-measured quantity (a common recipe measure) of firmly packed brown sugar.

Another aspect of the invention comprises an article that comprises a plurality of pre-measured portions corresponding to common recipe measure, each enclosed in an individual container. Another aspect of the invention is the article wherein the plurality of pre-measured portions comprises a plurality of different sized portions.

Another aspect of the invention comprises a container containing a baking ingredient in compacted form, wherein said container is cleavable, and said container comprises a mark indicating a fraction of said pre-measured portion, wherein said container is cleavable at said mark to provide a second pre-measured portion.

### BRIEF DESCRIPTION OF THE DRAWINGS

FIG. 1 illustrates one embodiment of the invention, comprising a solid, compressed block of brown sugar wrapped with a suitable container bearing indicia indicating recipe measures.

FIG. 2 illustrates another embodiment of the invention, comprising a chain of bags joined end to end, each bag containing a pre-measured portion of a granular baking ingredient.

### DETAILED DESCRIPTION

Definitions:

The terms “common measure” and “recipe measure” as used herein refer to a volume commonly used in cooking by consumers, such as for example, one cup (American measure) or an integral fraction of 1 cup, such as, for example, ½ cup, ⅔ cup, ¾ cup, ⅓ cup, ¼ cup, ⅜ cup, 2 tablespoons, and the like. The common measure or recipe measure will be equal to or greater than ⅛ cup. The terms also include the corresponding Metric System units of measure, such as, for example, 1000 g, 500 g, 350 g, 250 g, 200 g, 100 g, 50 g, and the like, such as are found in recipes designed for European cooks.

The term “regular solid” refers to a simple geometric shape, such as a cube, rectangular prism, cylinder, triangular prism, tetrahedron, hexagonal prism, octagonal prism, and the like.

The term “brown sugar” as used herein refers to turbinado sugar, raw sugar, and similar products such as, without limitation, cane sugar with added molasses. Brown sugar as used in the invention is characterized by significant moisture content, the ability to retain the shape of a container into which it has been packed or compressed, and the ability to be compressed a significant percentage into a “firmly packed” form. It excludes sugar that had been granulated or otherwise treated to avoid caking if it does not compress or pack.

The term “granular chocolate” as used herein refers to chocolate (and chocolate substitutes) that is provided in a solid form ranging from fine powder to large “chocolate chips”.

The term “suitable container” as used herein refers to a container that is approved or approvable for use in packaging foods such as brown sugar, and that is capable of preserving the food's freshness for a period of time at least comparable to the existing containers used for marketing such foods.

General Method:

The packaging of the invention provides a convenient form for problematic cooking ingredients, such as brown sugar, grated or shredded coconut, and the like. Brown sugar can be particularly troublesome when packaged in bulk: once opened, brown sugar is hygroscopic and tends to form solid masses at the bottom of the package. This hardened sugar is difficult to extract from the package, difficult to measure accurately, and if it is not added to a liquid it is difficult to disperse evenly. Further, brown sugar must generally be firmly packed into a measuring implement in order to use a measured amount: this firmly packed brown sugar is also difficult to disperse evenly. Other ingredients, such as baking chocolate (although available in 1 oz squares and “chocolate chips”) and shredded coconut share some of these difficulties. For example, 1 oz squares of baking chocolate are time-consuming to melt, while smaller chocolate chips are prone to clump if exposed to heat, and are difficult to accurately measure.

One embodiment of the invention comprises a package comprising a pre-measured portion of a baking ingredient, wherein said pre-measured portion corresponds to an amount commonly used in consumer recipes, such as ½ cup, ⅔ cup, ¼ cup, ⅛ cup, 2 tablespoons (Tbs), 200 g, 250 g, and the like. The portion packages can be fabricated from papers, waxed paper, foil, various plastics, and the like, and combinations thereof (for example, cardboard lined with waxed paper or metal foil) that are suitable for use in food packaging. The portion packages can further be scored, perforated or semi-perforated for ease in opening.

Another aspect of the invention is a storage package comprising a plurality of individual pre-measured portions contained within a larger container, such as four ¼ cup portions, where each ¼ cup portion is separately wrapped (for example, in individual polyethylene bags) and contained within a cardboard box. In another presently preferred embodiment, the package comprises a plurality of pre-measured portions of different sizes. For example, a package can contain one ½ cup portion, two ⅓ cup portions, and two ¼ cup portions, enabling the consumer to measure ¼ cup, ⅓ cup, ½ cup, ⅔ cup, ¾ cup, or 1 cup portions simply by opening one or two bags (three in the case of 1 cup). It is an advantage of the invention that the outer package need not be airtight, as the inner individual portions can serve to maintain the product freshness.

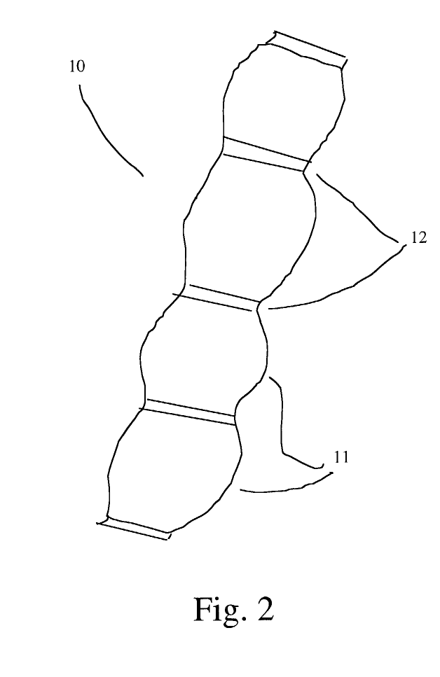

Alternatively, the bags may be joined in a chain or bunch, as depicted in FIG. 2. In this embodiment, the bags can be of identical sizes or assorted sizes. The bags can be fashioned separately, followed by joining together using adhesive, a restraining band, or by heat-sealing ends together. Alternatively, the bags (11) can be formed by heat-sealing (or otherwise crimping) (12) a continuous tube of plastic film. A continuous chain (10) can be marketed without the requirement of an enclosing box, presenting the consumer with the opportunity to tear off an purchase only as many “units” as are desired.

Where the baking ingredient is brown sugar, a presently preferred embodiment provides a pre-measured quantity of loosely packed brown sugar that corresponds to a pre-measured common measure of firmly packed brown sugar, thus obviating the need to pack the brown sugar for measurement, or to measure it at all. Thus, a package of the invention can contain, for example, a plurality of bags labeled ½ cup, ⅓ cup, and ¼ cup, but which in fact contain a larger volume of unpacked brown sugar that corresponds to the indicated volume of firmly packed brown sugar. The exact amount contained in the bags will vary depending on the properties of the sugar and the degree to which the “loose” sugar is packed, but in general will be at least about 120% of the volume indicated, preferably at least about 140%, more preferably at least about 150%, and preferably less than about 300%, more preferably less than about 250% of the indicated volume. As a rule of thumb, firmly packing brown sugar reduces its volume by about 50%. By providing the sugar in a pre-measured “unpacked” form, the consumer no longer needs to pack the brown sugar into a measuring cup for measurement, followed by unpacking into a mixture of other ingredients.

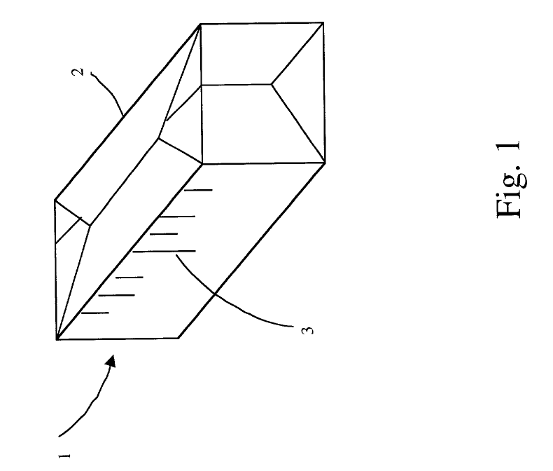

In another embodiment, brown sugar is provided in firmly packed form in pre-measured portions, as depicted in FIG. 1. In this embodiment, the sugar is packed into a regular solid (1), such as a cube, rectangular prism, hexagonal prism, cylinder, lozenge, tablet, or the like, which corresponds to a common cooking measure, such as ½ cup, ⅓ cup, 200 g, and the like. Individual portions are preferably individually wrapped (2), analogously to individually wrapped sticks (“cubes”) of butter. The individual portions are preferably further marked with indicia (3) indicating fractions of the portion that correspond to common measures: for example, a ½ cup portion can be marked to indicate the fraction of the portion that provides ⅜ cup, ⅓ cup, ¼ cup, ⅛ cup, ⅛ cup, 2 Tbs, and the like. The marks can be provided on the portion wrapper (if present), or can be stamped or molded directly into the solid portion. To use, the consumer simply cuts through the solid, for example using a knife, at the position indicated to provide the desired measured quantity of brown sugar. The solid can be cut without first unwrapping it, if a suitable container or wrapping material is used, such as, for example, thin foil or waxed paper. Alternatively, the solid portion can be fashioned such that it contains a common measure per unit length, for example, 2 Tbs per inch (or per any arbitrary unit). In such cases, the package preferably includes a scale indicating the point at which any solid supplied therewith should be cut in order to provide any desired amount of brown sugar. The scale can be provided as printing along an edge of the package (for example, along the longest side of a box), or can be provided as a separate article, for example, as a plastic strip marked to indicate units corresponding to common measures (regardless of whether the units correspond to inches, centimeters, or any typical unit of length).

Another aspect of the invention comprises a scale/cutting aid to facilitate cutting a pre-measured portion of a brown sugar solid, comprising a first generally flat surface having a longer length than width, joined at an angle along its length to a second surface, wherein the first and second surfaces are shaped to receive a brown sugar solid form, and wherein at least one of said first and second surfaces is marked to indicate a length of brown sugar solid that corresponds to a common measure. The cutting aid can be fabricated from wood or metal, molded from plastic, or fashioned from other materials.

One embodiment of the cutting aid of the invention has a generally planar base with a scale inscribed along one edge, perpendicular to an end stop and an edge ridge, and optionally a supplemental scale along its length. The scale(s) are marked to indicate the length of solid form required to provide a desired common measure of the ingredient, and will vary depending on the dimensions of the solid selected for use with the cutting aid. In use, a solid form of the invention is placed on the base against the end stop and edge ridge surfaces, which hold the solid in position. The user then locates the position on the scale corresponding to the quantity desired, and cuts the portion with a knife or other implement. If a supplemental scale is present, the user can line up the knife with corresponding marks on both sides of the solid, and thus cut more accurately.

What is claimed:

1. An article of manufacture, comprising: a pre-measured portion of a granular baking ingredient, enclosed in a suitable container.

2. The article of claim 1, wherein said pre-measured portion is larger than ⅛ cup.

3. The article of claim 1, wherein said pre-measured portion is selected from the group consisting of 1 cup, ¾ cup, ⅔ cup, ½ cup, ⅓ cup, ¼ cup, and ⅛ cup.

4. The article of claim 1, wherein said pre-measured portion is selected from the group consisting of 250 g, 200 g, 150 g, 100 g, and 50 g.

5. The article of claim 1, wherein said baking ingredient comprises granular chocolate.

6. The article of claim 1, wherein said baking ingredient comprises brown sugar.

7. The article of claim 6, wherein said brown sugar comprises loosely-packed brown sugar, and said pre-measured portion is an amount equivalent to a pre-measured quantity of firmly-packed brown sugar.

8. The article of claim 1, wherein said article comprises a plurality of pre-measured portions, each enclosed in an individual container.

9. The article of claim 8, wherein said plurality of pre-measured portions comprises a plurality of different sized portions.

10. The article of claim 9, wherein at least one pre-measured portion size is selected from the group consisting of 1 cup, ¾ cup, ⅔ cup, ½ cup, ⅓ cup, ¼ cup, and ⅛ cup.

11. The article of claim 9, wherein at least one pre-measured portion size is selected from the group consisting of 250 g, 200 g, 150 g, 100 g, and 50 g.

12. The article of claim 1, wherein said container is cleavable, and said article comprises a mark indicating a fraction of said pre-measured portion, wherein said container is cleavable at said mark to provide a second pre-measured portion.

13. The article of claim 12, wherein said baking ingredient comprises brown sugar.

14. The article of claim 13, wherein said brown sugar comprises firmly packed brown sugar, in the shape of a regular solid.

15. The article of claim 14, wherein said second pre-measured portion is selected from the group consisting of ¾ cup, ⅔ cup, ½ cup, ⅓ cup, ¼ cup, and ⅛ cup.

16. The article of claim 12, wherein said article comprises a plurality of marks.

17. The article of claim 12, wherein said mark is present on said container.

18. The article of claim 14, wherein said marks are present on the surface of said regular solid.

19. An article of manufacture, comprising a plurality of bags, each bag comprising a pre-measured portion of a granular baking ingredient.

20. The article of claim 19, wherein the granular baking ingredient comprises brown sugar.

21. The article of claim 19, wherein said pre-measured portion is selected from the group consisting of ¾ cup, ⅔ cup, ½ cup, ⅓ cup, ¼ cup, and ⅛ cup.

22. The article of claim 19, wherein said plurality of bags comprises at least four bags.

23. The article of claim 19, wherein each bag contains an identical pre-measured portion.

24. The article of claim 19, wherein said plurality of bags are joined end to end in a chain.
